(19) United States
(12) Patent Application Publication
(10) Pub. No.: US 2004/0193891 A1
(43) Pub. Date: Sep. 30, 2004

(54) Integrity check value for WLAN pseudonym

(76) Inventor: Juha Ollila, Oulu (FI)

Correspondence Address: SQUIRE, SANDERS & DEMPSEY L.L.P., 14TH FLOOR, 8000 TOWERS CRESCENT, TYSONS CORNER, VA, 22182, US

(21) Appl. No.: 10/615,461

(22) Filed: Jul. 9, 2003

(30) Foreign Application Priority Data
Mar. 31, 2003 (EP) 03007256.5

(51) Int. Cl. H04K 1/00

(52) U.S. Cl. 713/182

(57) ABSTRACT

The invention proposes a method for generating a subscriber identifier, comprising the steps of generating an identifier base string based on encrypting a subscriber identifying value, generating an integrity check value based on the identifier base string, and generating a subscriber identifier based on a concatenation of the identifier base string and the integrity check value. The invention also proposes a corresponding network control node.

### BACKGROUND OF THE INVENTION

1. Field of the Invention

The invention relates to a method and a system for generating a subscriber identifier, and in particular for generating a temporal identifier such as a pseudonym.

2. Description of the Related Art

As described above, the invention relates to generating a subscriber identifier and in particular to generating a temporary identifier such as a pseudonym, in a network. Pseudonyms are used to provide a user with privacy. That is, when accessing a network service, the user might not always wish to expose his true identity. Pseudonyms offer this possibility. However, in case an arbitrary pseudonym is used, it is impossible to judge whether a user using a pseudonym is entitled to use, for example, a particular service or not. For this reason, a pseudonym is generated by an authentication server, which performs an authentication and, therefore, can validate a used pseudonym.

As an access method, WLAN (Wireless Local Area Network) can be used as an alternative access method to Third Generation Partnership Project (3GPP) networks. WLAN access shall provide as good network access security as GSM or UMTS access methods. 3GPP network access provides the following security services:

User identity confidentiality (including user location confidentiality and user untraceability). This is achieved using a temporary identity, as described above. To avoid traceability, temporary identities are not used for long periods.

User authentication

Network authentication

Confidentiality of data

Integrity of data

WLAN network access security is based on the Extensible Authentication Protocol (EAP), EAP-SIM (EAP-Subscriber Identity Module) and EAP-AKA (EAP-Authentication and Key Agreement) as specified in RFC 2284: “PPP Extensible Authentication Protocol (EAP)” by L. Blunk and J. Vollbrecht, March 1998 (www.ietf.org/rfc/rfc2284.txt), “EAP SIM Authentication” by H. Haverinen and J. Salowey, January 2003 (draft-haverinen-pppext-eapsim, www.ietf.org/intemet-drafts/draft-haverinen-pppext-eap-sim-09.txt), and “EAP AKA Authentication” by J. Arkko and H. Haverinen, January 2003 (draft-arkko-pppext-eapaka, www.ietf.org/internet-drafts/draft-arkko-pppext-eap-aka-08.txt).

Both EAP-SIM and EAP-AKA authentication methods provide the confidentiality of user identity based on the use of pseudonyms.

In particular, during an authentication procedure, an authenticating node (Authenticator node) which may be an AAA (Authentication, Authorization and Accounting) server optionally provides a temporary identity, i.e., a pseudonym to the WLAN client (e.g., the subscriber). The WLAN client can present it as a user identity for subsequent authentication attempts. The EAP-SIM/AKA specifications do not define a method for the generation of pseudonyms, and leave that issue as an implementation decision. Nevertheless, in order to make it possible in 3GPP networks that pseudonyms provided by one AAA server can be recognized by another AAA server (potentially from another vendor), some standardization is necessary.

According to an approach described in “WLAN—Pseudonym Generation for EAP-SIM/AKA” (ftp.3gpp.org/tsg_sa/WG3_Security/TSGS3_{—}26_Oxford/Docs/PDF/S3-020654.pdf), presented on the 3GPP TSG SA WG3 Security meeting, Nov. 19-22, 2002, Oxford, UK, the following format for a pseudonym is proposed:

Pseudonym=Base64 (TAG∥Key indicator∥AES(padding∥BCD(IMSI)∥random number))

Where:

Base64( )=base 64 conversion,

∥=concatenation,

TAG is used to indicate that WLAN identity is pseudonym,

Key indicator indicates used keys,

AES=AES encryption algorithm in ECB mode,

Padding=the most significant bits will be padded by setting all the bits to 1, so that length of (padding∥BCD(IMSI)) is 64 bits,

BCD( )=binary coded decimal conversion, and

Random number=64-bit (8 octets) random number.

As a basis for generating the pseudonym, an encrypted IMSI (International Mobile Subscriber Identity) is used. In this way, it is assured that there is a connection between the subscriber and the pseudonym, but by using the encryption, the true identity cannot easily be discovered by unauthorized other subscribers or the like.

The IMSI is not longer than 15 digits and consists of three parts: MCC (Mobile Country Code) for identifying the country of the subscriber, usually 3 digits, MNC (Mobile Network Code) for identifying the particular home network, usually 2 to 3 digits, and MSIN (Mobile Subscriber Identifying Number), which should be no more that 10 digits. MCC and MNC uniquely identify the operator.

For the encryption, first a BCD (Binary Coded Decimal) conversion is carried out on the IMSI. In this way, a compressed IMSI is generated by using 4 bits to represent each digit of the IMSI. That is, the compressed IMSI is:

Compressed IMSI=BCD(IMSI)

The length of the IMSI is not more than 15 digits (numerical characters, 0 to 9). The length of the compressed IMSI should be 64 bits (8 octets). Since the length of the IMSI is maximum 15×4 bits=60 bits, the most significant bits (here, the 4 leading bits) will be padded by setting all the bits to 1. It is noted that by the BCD conversion, none of the converted digits of the IMSI can be 1 since each digit is represented by 4 bits. Therefore, the padding (setting the most significant bits to 1) can be easily detected and removed, such that the compressed IMSI can be determined.

Then, a padded IMSI is created by concatenating an 8-octet random number to the compressed IMSI. This random number ensures a predetermined length, i.e., block size, and in addition it contributes to the requirement that the IMSI should not be easily decrypted. Thus, the padded IMSI is:

Padded IMSI=padding∥BCD(IMSI)∥random number

The thus generated padded IMSI is encrypted by the IMSI with Advanced Encryption Standard (AES) in Electronic Codebook (ECB) mode of operation by using a ciphering key, for example a 128-bit secret key. The encrypted IMSI has the following format:

Encrypted IMSI=AES(padding∥BCD(IMSI)∥random number)

After generating the encrypted IMSI, some more fields are provided. A key indicator is used in order that the AAA server that receives the pseudonym can locate the appropriate key to decrypt the encrypted IMSI. Moreover, a pseudonym tag is used to mark the identity as a pseudonym.

All these fields are concatenated to each other, in the form

Tag∥Key Indicator∥Encrypted IMSI.

This concatenation is converted to a printable string by using a BASE64 method.

Validity of a pseudonym is verified by decrypting the result of the AES function (i.e., decrypting the encrypted IMSI) and checking that padding, MCC and MCN are correct.

In this way, some reliability on the security is achieved.

However, as described above, the validation of a pseudonym requires a full decryption of the pseudonym. This involves large processing, and this can be exploited by so-called DoS (Denial of Service) attacks, for example.

When performing DoS attacks, an attacker tries to generate an overload of a particular server such that this server can no longer provide a sufficient function. When doing so, the attacker can send multiple EAP-Response/Identity message with bogus pseudonyms. The AAA server decrypts every pseudonym using the AES algorithm, checks padding and part of the IMSI (MCC and MCN) and rejects bogus pseudonyms.

Thus, the processing required for each bogus pseudonym is considerable such that an overload is often generated.

Moreover, an attacker can generate bogus pseudonyms randomly in order to access a service or the like. There is a certain probability that the attacker might succeed. Therefore, it is desirable to further improve the security, by reducing the probability that an attacker is able to find the correct pseudonym, i.e., to forge a pseudonym.

### SUMMARY OF THE INVENTION

Thus, according to one aspect of the invention, a further enhanced security and privacy for a user of a pseudonym may be provided.

To this end, a method for generating a subscriber identifier may include the steps of generating an identifier base string based on encrypting a subscriber identifying value, generating an integrity check value based on the identifier base string, and generating a subscriber identifier based on a concatenation of the identifier base string and the integrity check value.

According to another aspect of the invention, a network control node for generating a subscriber identifier includes a mechanism for generating an identifier base string based on encrypting a subscriber identifying value, a mechanism for generating an integrity check value based on the identifier base string, and a mechanism for generating a subscriber identifier based on a concatenation of the identifier base string and the integrity check value.

Thus, according to certain embodiments of the invention, an integrity check value is added to the subscriber identifier. In this way, the subscriber identifier (which may be a pseudonym) can be validated by only referring to the integrity check value. Namely, in case the integrity check value is not correct, e.g., in case the integrity check fails, it can be determined that the subscriber identifier is corrupted, e.g., a bogus subscriber identifier.

Hence, the processing for validating a subscriber identifier or a pseudonym can be simplified such that a server can be more resistant against DoS attacks.

Furthermore, in accordance with particular embodiments of the invention, the additional integrity check value provides more protection against forgery.

During generating the identifier base string in one embodiment, the subscriber identifying value may be binary coded, a random number may be concatenated, and an encryption algorithm may be performed on the concatenated binary coded subscriber identifying value and the random number, for generating the identifier base string.

During generating the subscriber identifier, a base 64 conversion may be performed on the concatenated identifier base string and the integrity check value.

Moreover, a key indicator for indicating a used ciphering key may be concatenated to the value obtained by the encryption of the subscriber identifying value.

Furthermore, according to other aspects of the invention, an identifier type indicator for indicating that the identifier is a particular identifier type may be used, wherein during generating the identifier base string, the identity type indicator may be concatenated to the value obtained by the encryption of the subscriber identifying value.

In certain embodiments, during performing the encryption algorithm, a defined length may be provided for the concatenated binary coded subscriber identifying value and the random number, wherein the most significant bits not used for the binary coded subscriber identifying value may be set to 1, respectively.

During generating the integrity check value, a pseudo random function may be performed on the identifier base string using an integrity key.

Moreover, a key indicator for indicating a used ciphering key and the integrity key used for generating the integrity check value may be used, wherein during generating the identifier base string the key indicator may be concatenated to the value obtained by the encryption of the subscriber identifying value.

The pseudo random function may be a keyed hash function or other suitably equivalent function.

The calculated result of the pseudo random function performing step may be truncated to a predetermined amount of bits.

The subscriber identifying value may be an International Mobile Subscriber Identity.

In addition, one embodiment of the invention also includes a method for validating a subscriber identifier, wherein the subscriber identifier comprises a format including at least an integrity check value, the method including the steps of detecting an integrity check value of a received subscriber identifier, performing an integrity check based on the integrity check value and the subscriber identifier, and rejecting the subscriber identifier in case the integrity check reveals that the subscriber identifier is not valid.

Additional embodiments include a network control node for validating a subscriber identifier, where the subscriber identifier has a format including at least an integrity check value, the network control node including a component for detecting an integrity check value of a received subscriber identifier, a component for performing an integrity check based on the integrity check value and the subscriber identifier, and a component for rejecting the subscriber identifier in case the integrity check reveals that the subscriber identifier is not valid.

Thus, a invalid subscriber identity may be rejected only passed on the integrity check. Hence, a subscriber identity protected with an integrity check value can easily be validated without performing complicated decryption operations.

Moreover, in case the integrity check is successful, the subscriber identifier may be decrypted in order to perform a further detailed validation of the subscriber identity.

The network control node may be an AAA (Authentication, Authorization, and Accounting) server or other server having suitable functionality.

In another aspect of the invention, a computer program product includes software code portions for performing the steps of the methods described herein when the product is run on a computer.

The computer program product may include a computer-readable medium on which the software code portions are stored. The computer program product may be directly loadable into the internal memory of the computer.

### BRIEF DESCRIPTION OF THE DRAWINGS

FIG. 1 shows a flowchart illustrating a process of generating a pseudonym according to an embodiment of the present invention;

FIG. 2 shows a flowchart illustrating a process of validating a pseudonym according to an embodiment of the present invention; and

FIG. 3 shows a flowchart illustrating a process of verification of a pseudonym by decrypting the pseudonym.

### DETAILED DESCRIPTION OF THE PREFERRED EMBODIMENTS

In the following, the invention is described in detail by referring to a preferred embodiment.

According to one aspect of the invention, an integrity check value (ICV) is added to a subscriber identifier which may be, e.g., a temporary subscriber identifier or a pseudonym. In particular, this ICV is derived from the pseudonym in the form before it is subjected to the Base 64 Conversion, as described previously. This form is referred to as the identifier base string or pseudonym base string in the following.

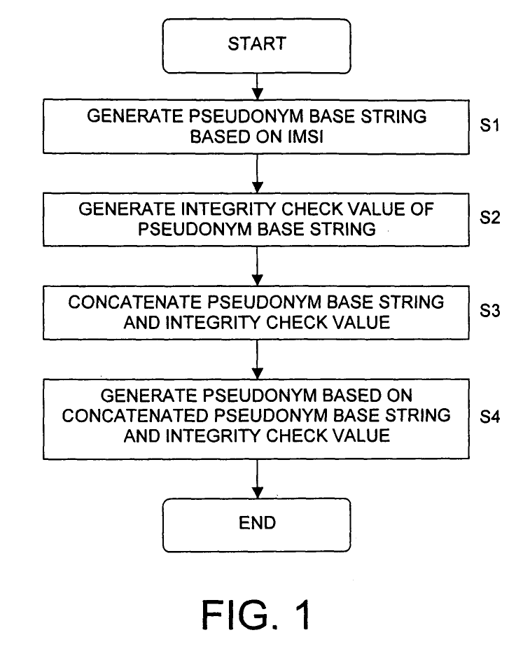

The general procedure according to one embodiment is described by referring to the flowchart shown in FIG. 1.

In step S1, the pseudonym base string is generated based on a general subscriber identifying value, such as the IMSI. In step S2, an ICV (Integrity Check Value) of the pseudonym base string is produced. After this, in step S3 the pseudonym base string and the integrity check value are concatenated. In step S4, the final pseudonym is created based on the concatenated pseudonym base string and the ICV. In the simplest way, the concatenated result of step S3 can be used as the pseudonym. Preferably, however, a Base 64 conversion is performed on this result such that a printable string is obtained.

Thus, the pseudonym obtained as described above has the following format:

Pseudonym=Base64(Pseudonym base string∥ICV)

The ICV is obtained, for example, by adopting a pseudo random function (PRF) with an integrity key on the pseudonym base string:

ICV=PRF (Integrity key, Pseudonym base string)

In the following, the procedure according to the present embodiment is described in more detail.

Preferably, the pseudonym according to the embodiment is in the following format:

Pseudonym=Base64(TAG∥Key indicator∥AES(padding∥BCD(IMSI)∥random number)∥ICV),

where:

Base64( )=base 64 conversion

∥=concatenation

TAG is used to indicate that WLAN identity is pseudonym.

Key indicator indicates used keys,

AES=AES encryption algorithm in ECB mode,

Padding=the most significant bits will be padded by setting all the bits to 1, so that length of (padding∥BCD(IMSI)) is 64 bits.

BCD( )=binary coded decimal conversion.

Random number=64-bit (8 octets) random number.

ICV=integrity check value.

That is, the above-described pseudonym base string has the following format:

TAG∥Key indicator∥AES(padding∥BCD(IMSI)∥random number)

The pseudonym base string can be generated as described above, namely as described in document “WLAN—Pseudonym Generation for EAP-SIM/AKA” <ftp://ftp.3gpp.org/tsg_sa/WG3_Security/TSGS3_{—}26_Oxford/Docs/PDF/S3-020654.pdf>.

In the following, the generation of the ICV for the pseudonym is described.

ICV=TRUN (PRF (integrity key, (TAG∥Key indicator∥AES (padding∥BCD(IMSI)∥random number))), where:

TRUN=truncates calculated result of PRF to 96 bits.

PRF(key, data)=pseudo random function e.g. keyed hash function.

Truncation is used, because according to standards, the NAI (Network Address Identifier) has maximum length of 72 octets. If length of truncated ICV is 96 bits (n=96), then length of pseudonym is 39 octets after base64 encoding and realm part of NAI can be 33 octets. Truncation has advantages (less information on the hash result available to an attacker) and disadvantages (less bits to predict for the attacker). Preferably, different keys are used for the decryption and for the calculation of ICV, but the key indicator identifies both keys, such that the key indicator can be referred to as key pair indicator.

For the pseudo random function, a keyed hash function may be used, as described above. Such a keyed hash function may be SHA-1 or MD5, for example. A keyed hash function such as SHA-1 is described in FIPS Publication 180-2: “Specifications for the Secure Hast Standard”, Aug. 1, 2002, for example. Thus, the ICV is calculated using such a keyed hash function with a data integrity key.

When using SHA-1, the above calculation of the ICV is in detail as shown in the following procedure:

ICV=TRUN (PRF (SHA-1 (TAG∥Key indicator∥AES (padding∥BCD(IMSI)∥random number))∥data integrity key∥padding of SHA-1)),

The format of the padding of SHA-1 is also specified in the above-referenced FIPS publication 180-2. The length of the data integrity key is 160 bits.

In this way, the thus determined integrity check value (ICV) is added into the pseudonym. Therefore, according to the present embodiment, validation of the pseudonym is more secure and resistance of DoS (Denial of Service) attacks is better.

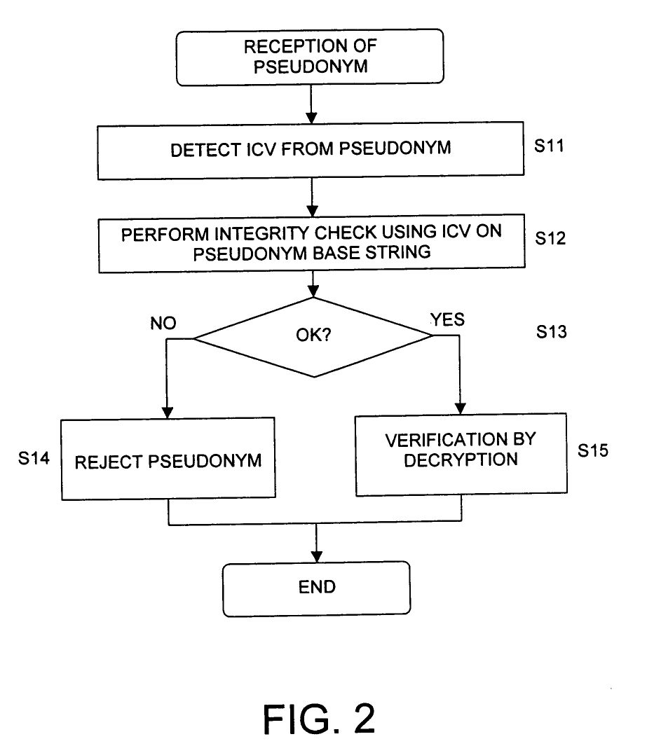

The flowchart of FIG. 2 illustrates the procedure carried out when an Authenticator Node (e.g., an AAA server) validates a pseudonym received from a subscriber (e.g., WLAN client).

In step S11, the AAA server extracts the ICV from the pseudonym. This can be achieved by performing an inverted Base 64 conversion, such that the printable string (which was achieved during the pseudonym generation in step S4 of FIG. 1) is converted into a series of digits again. Then, the ICV can be separated from the pseudonym base string. Thereafter, in step S12 the AAA server performs an integrity check by using the ICV on the pseudonym base string. That is, the AAA server calculates an ICV and compares the result with the received ICV (i.e., the ICV attached to the received pseudonym).

If the result is positive, i.e., if the calculated ICV is equal to the received ICV, (yes in step S13), the process advances to step S15. Here, further decryption can be taken by using AES and the like in order to determine the original IMSI, if necessary.

If, however, the result of the ICV check (step S12) is negative (i.e., the calculated ICV does not match with the received ICV), that is, if the integrity of the pseudonym cannot be verified (no in step S13), the process advances to step S14, in which the pseudonym is rejected.

That is, according to one embodiment, an ICV check may be sufficient in order to reject a bogus pseudonym. Hence, it is not necessary to carry out the full decryption on every pseudonym received.

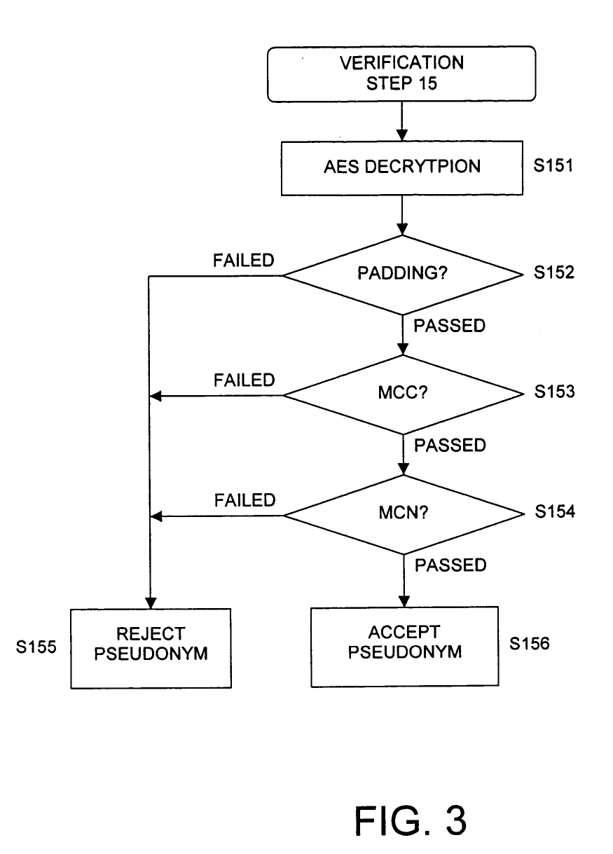

In the following, an embodiment for full verification of the pseudonym, e.g., the procedure in step S15, is described with reference to FIG. 3. In step S151, an AES decryption is performed. Then, three further check steps are performed. In step S152 the padding is checked, in step S153 the MCC part of IMSI is checked, and in step S154 the MCN part of IMSI padding is checked. Preferably, when all three checks are passed, the pseudonym is accepted (step S156). If in any of the steps S152 to S154 the verification fails, the pseudonym may be rejected (step S155).

In the following, an example of key management is described. As mentioned above, a 128-bit encryption key (for AES encryption) and a 160-bit data integrity key (for ICV calculation) is used for the generation of pseudonyms for a given period of time determined by the operator. Once that time has expired, a new key pair can be configured at all the WLAN AAA servers. The old key pairs are preferably no longer used for the generation of pseudonyms, but the AAA servers keep a number of suspended (old) key pairs for the interpretation of received pseudonyms that were generated with those old key pairs. The number of suspended key pairs kept in the AAA servers (up to 16) should be set by the operator, but it must be at least one, in order to avoid that a just-generated pseudonym becomes invalid immediately due to the expiration of the key.

Each key pair has associated a Key Pair Indicator value. This value is included in the pseudonym, as described above, so that when a WLAN AAA receives the pseudonym, it can use the corresponding key pair for obtaining the IMSI (and thence the Username).

It is noted that, if a pseudonym is sent to a WLAN client but then the user does not initiate new authentication attempts for a long period of time, the key pair used for the generation of that pseudonym will eventually be removed from all the WLAN AAA servers. If the user initiates an authentication attempt after that time, using that old pseudonym, the receiving AAA server will not be able to recognize the pseudonym as a valid one, and it will request the permanent user identity from the WLAN client. In order to use permanent user identities as little as possible, it is recommended that the key pair not be renewed very often. The configuration of the key pairs could be done via O&M (Operation & Management), for example. Handling of these secret keys, including generation, distribution and storage, should be done in a secure way.

As described above, when performing DoS attacks, an attacker can send multiple EAP-Response/Identity messages with bogus pseudonyms. If the procedure according to an embodiment of the present invention is not used, the AAA server decrypts every pseudonym using AES algorithm, checks padding and part of IMSI (MCC and MCN) and rejects bogus pseudonyms. When the number of the EAP-Response/Identity messages is large, the operation load on the AAA server may get very large such that the normal function of the AAA server may be disrupted.

If, however, an embodiment of the invention is used, the AAA server calculates only the ICV using a keyed hash algorithm for every pseudonym. Thus, it can reject bogus pseudonyms before decryption (step S14 in FIG. 2). Keyed hash algorithms are faster than AES algorithm, so the AAA server can resist heavier DoS attacks. E.g. SHA-1 is 50% faster than AES (Rijndael) and MD5 is over 3 times faster than AES, see, for example, <www.eskimo.com/˜weidai/benchmarks.html>.

Moreover, also the detection of forgery is improved. In the following calculations, it is assumed that an attacker generates bogus pseudonyms randomly.

If a pseudonym according to the embodiments of the invention is not used, AAA checks padding, MCC and MCN to detect forgery. In worst case, the probability that an attacker can forge a random pseudonym is ½\hat{ }24, because there are only 3 octets (24 bits, namely 3*4 bits for MCN, 2*4 bits for MCC and 1*4 bits padding) to ensure the validity of pseudonym. Namely, as described above, for a valid pseudonym, only MCN, MCC and padding is checked. It is noted that here “the worst case” means that IMSI cannot be longer than 15 digits. If IMSI is shorter, then there are more bits to ensure the validity of pseudonym (padding is longer).

The probability that an attacker can forge a pseudonym corresponding to a certain IMSI is ½\hat{ }64, because there are 8 octets (64 bits, length of the compressed IMSI having 60 bits and 4 bits padding) to ensure validity of pseudonym.

If, however, a pseudonym according to the invention is used, AAA server checks ICV, padding, MCC and MCN to detect forgery. In worst case, the probability that an attacker can forge a random pseudonym is ½\hat{ }96*½\hat{ }24=½\hat{ }120, when ICV is truncated into 96 bits. The probability that an attacker can forge a pseudonym corresponding certain IMSI is ½\hat{ }96*½\hat{ }64=½\hat{ }160.

Thus, according to the invention, a more reliable detection of bogus/forged pseudonyms is achieved, and a higher resistance against DoS attacks can be obtained.

It should be understood that the above description and accompanying figures are merely intended to illustrate the present invention by way of example embodiments only. The invention is thus not limited to the embodiments described herein, and is limited only by scope of the attached claims and their legal equivalents.

For example, according to an embodiment described above, the pseudonym base string (identifier base string) is generated such that is has the following format:

TAG∥Key indicator∥AES(padding∥BCD(IMSI)∥random number)

The invention, however, is not limited onto this particular format. For example, the order of the different fields can be changed arbitrarily. Moreover, some of the fields can be omitted. For example, if the used ciphering key is negotiated in another way (for example, if it is determined beforehand that a particular AAA server only use one particular key), the Key Indicator field may be omitted. Furthermore, if it is not considered necessary to indicate that this particular subscriber identifier is a pseudonym, also the TAG field may be omitted. In the same way, also the padding or the random number may be omitted, in order to simplify the processing in the AAA server. In addition, alternative coding procedures (instead of BCD) and encryption algorithms (instead of AES) may be adopted.

Furthermore, the procedure according to the embodiments described above is situated in a WLAN environment. However, also other suitable networks may be employed, as long as they permit the use of temporary identifiers or pseudonyms.

Moreover, the example embodiments are directed to the establishment of a pseudonym. However, the invention is not limited thereon. For example, also temporary or permanent subscriber identifiers may be generated using the procedure according to the present invention. Namely, for example, DoS attacks can also be performed by using bogus subscriber identifiers (which may be known) instead of pseudonyms. When adopting the procedure according to the invention, it is also sufficient to calculate the ICV only, without the necessity to perform a full decryption.

According to the above examples, two different keys are used for encrypting the pseudonym base string and the ICV. However, it is also possible to use identical keys in order to simplify the procedure. However, the use of two different keys may enhance security.

In addition, as described above, the ICV is truncated to 96 bits. This, however, is only an example and the ICV may be truncated to any other number of bits, for example depending on the number of bits available in the subscriber identifier. If possible, also no truncation at all may be performed.

The invention defines a method for generating a subscriber identifier, including the steps of generating an identifier base string based on encrypting a subscriber identifying value (S1; FIG. 1), generating an integrity check value based on the identifier base string (S2), and generating a subscriber identifier based on a concatenation of the identifier base string and the integrity check value (S3, S4). The invention also relates to a corresponding network control node.

1. A method for generating a subscriber identifier, comprising the steps of:
generating an identifier base string based on encrypting a subscriber identifying value;
generating an integrity check value based on the identifier base string; and
generating a subscriber identifier based on a concatenation of the identifier base string and an integrity check value.

2. The method according to claim 1, wherein generating the identifier base string comprises the steps of:
binary coding of the subscriber identifying value,
concatenating a random number, and
performing an encryption algorithm on the concatenated binary coded subscriber identifying value and the random number, for generating the identifier base string.

3. The method according to claim 1, wherein in the subscriber identifier generating step, a base 64 conversion is performed on the concatenated identifier base string and the integrity check value.

4. The method according to claim 1, further comprising the step of using a key indicator for indicating a used ciphering key,
wherein in the identifier base string generating step, the key indicator is concatenated to the value obtained by the encryption of the subscriber identifying value.

5. The method according to claim 2, further comprising the step of using an identifier type indicator for indicating that the subscriber identifier is a particular identifier type, wherein in the identifier base string generating step, the identity type indicator is concatenated to the value obtained by the encryption of the subscriber identifying value.

6. The method according to claim 2, wherein in the performing encryption algorithm step, a defined length is provided for the concatenated binary coded subscriber identifying value and the random number, wherein most significant bits not used for the binary coded subscriber identifying value are set to 1, respectively.

7. The method according to claim 1, wherein the integrity check value is generated by performing a pseudo random function on the identifier base string using an integrity key.

8. The method according to claim 7, further comprising the step of using a key indicator for indicating a used ciphering key and the integrity key used for generating the integrity check value, wherein the key indicator is concatenated to a value obtained by encryption of the subscriber identifying value.

9. The method according to claim 7, wherein the pseudo random function is a keyed hash function.

10. The method according to claim 7, wherein a calculated result of performing the pseudo random function is truncated to a predetermined amount of bits.

11. The method according to claim 1, wherein the subscriber identifying value is an International Mobile Subscriber Identity.

12. A method for validating a subscriber identifier, wherein the subscriber identifier comprises a format including at least integrity check values, the method comprising the steps of:
detecting an integrity check value of a received subscriber identifier,
performing an integrity check based on the integrity check value and the subscriber identifier, and
rejecting the subscriber identifier in case the integrity check reveals that the subscriber identifier is not valid.

13. The method according to claim 12, further comprising the step of
decrypting the subscriber identifier in case the integrity check is successful.

14. A network control node for generating a subscriber identifier, the network node comprising:
means for generating an identifier base string based on encrypting a subscriber identifying value;
means for generating an integrity check value based on the identifier base string; and
means for generating a subscriber identifier based on a concatenation of the identifier base string and the integrity check value.

15. The network control node according to claim 14, wherein the identifier base string generating means comprises:
means for binary coding of the subscriber identifying value;
means for concatenating a random number to the binary coded subscriber identifying value; and
means for performing an encryption algorithm on the concatenated binary coded subscriber identifying value and random number, for generating the identifier base string.

16. The network control node according to claim 14, wherein the subscriber identifier generating means is adapted to perform a base 64 conversion on the concatenated identifier base string and the integrity check value.

17. The network control node according to claim 14, wherein the subscriber identifier generating means is adapted to concatenate a key indicator, for indicating a used ciphering key, to a value obtained by the encryption of the subscriber identifying value.

18. The network control node according to claim 14, wherein the subscriber identifier generating means is adapted to concatenate an identifier type indicator, for indicating that the subscriber identifier is a particular identifier type, to a value obtained by the encryption of the subscriber identifying value.

19. The network control node according to claim 15, wherein a defined length is provided for the concatenated binary coded subscriber identifying value and the random number and wherein the encryption algorithm performing means is adapted to set a value of one for the most significant bits not used for the binary coded subscriber identifying value.

20. The network control node according to claim 14, wherein the integrity check value generating means is adapted to perform a pseudo random function on the identifier base string using an integrity key.

21. The network control node according to claim 14, wherein the subscriber identifier generating means is adapted to concatenate a key indicator for indicating a used ciphering key and an integrity key used for generating the integrity check value to a value obtained by the encryption of the subscriber identifying value.

22. The network control node according to claim 20, wherein the pseudo random function is a keyed hash function.

23. The network control node according to claim 20, wherein the integrity check value generating means is adapted to truncate a calculated result of the pseudo random function to a predetermined amount of bits.

24. The network control node according to claim 14, wherein the subscriber identifying value is an International Mobile Subscriber Identity.

25. A network control node for validating a subscriber identifier, wherein the subscriber identifier comprises a format including at least integrity check values, the network control node comprising:
means for detecting an integrity check value of a received subscriber identifier:
means for performing an integrity check based on the integrity check value and the subscriber identifier; and
means for rejecting the subscriber identifier in case the integrity check reveals that the subscriber identifier is not valid.

26. The network control node according to claim 25, further comprising means for decrypting the subscriber identifier in case the integrity check is successful.

27. The network control node according to claim 25, wherein the network control node comprises an AAA (Authentication, Authorization, and Accounting) server.

28. A computer program product stored on a tangible medium, the product comprising software code, when executed by one or more processors, performs the steps of:
generating an identifier base string based on encrypting a subscriber identifying value;
generating an integrity check value based on the identifier base string; and
generating a subscriber identifier based on a concatenation of the identifier base string and an integrity check value.

29. The computer program product according to claim 28, wherein the computer program product comprises distributed components stored in more than one location of a network.

30. The computer program product according to claim 28, wherein said computer program product is directly loadable into the internal memory of a computer.

31. The computer program product according to claim 28, wherein the computer program product comprises a computer-readable medium on which said software code is stored.
